(19) United States
(12) Patent Application Publication
(10) Pub. No.: US 2011/0022466 A1
(43) Pub. Date: Jan. 27, 2011

(54) TRAVEL PROMOTION SYSTEM

(76) Inventors: Conrad R. Carney, II, Lexington, KY (US); James H. Johnson, JR., Lexington, KY (US)

Correspondence Address: KING & SCHICKLI, PLLC, 247 NORTH BROADWAY, LEXINGTON, KY, 40507, US

(21) Appl. No.: 12/841,338

(22) Filed: Jul. 22, 2010

Related U.S. Application Data
(60) Provisional application No. 61/227,555, filed on Jul. 22, 2009.

(51) Int. Cl. G06Q 30/00; G01S 19/42

(52) U.S. Cl. 705/14.55; 342/357.25

(57) ABSTRACT

A method of promoting travel includes the step of providing a website for promoting travel destinations for access by subscriber consumers and compiling promotional offers of all participating entities by travel destination. The method further includes allowing the subscriber consumer to select a travel destination and a promotional offer of interest. Further, the method includes sending the selected promotional offer to the subscriber consumer by means of text messaging on a mobile communication device of the subscriber consumer or customer.

This application claims priority to U.S. Provisional Patent Application Ser. No. 61/227,555 filed 22 Jul. 2009, the entire disclosure of which is incorporated herein by reference.

### TECHNICAL FIELD AND INDUSTRIAL APPLICABILITY OF THE INVENTION

The present invention relates generally to the marketing field and, more particularly, to a method of marketing and promoting travel utilizing mobile phone text messaging.

### BACKGROUND OF THE INVENTION

The marketing of goods and services by means of mobile phone text messaging is a rapidly growing field. The concept of narrow casting text messages to existing or potential business customers is known. Relevant prior art patents include U.S. Pat. No. 6,754,314 to Wengrovitz et al, U.S. Pat. No. 7,197,324 to Sweeney and U.S. Pat. No. 7,437,413 to Okuyama et al.

The present invention relates to a new and improved method of marketing and promoting travel using a mobile phone text messaging service.

### SUMMARY OF THE INVENTION

The present invention relates generally to a method of promoting travel. The method comprises the steps of providing a website for promoting travel destinations for access by a subscriber consumer, compiling promotional offers of all participating entities by travel destination and allowing the subscriber consumer to select a travel destination and a promotional offer of interest at that travel destination. The method further includes sending the selected promotional offer to the subscriber consumer by means of text messaging on a mobile communication device of the subscriber consumer.

In accordance with additional aspects of the present invention, the method includes determining the location of the subscriber consumer by monitoring the GPS system of the mobile communication device of the subscriber consumer. The method further includes sending the most up-to-date promotional offer to the mobile communication device of the subscriber consumer when the mobile communication device is detected at the travel destination. Further, the method includes sending travel directions to a site of a particular promotional offer.

In the following description there is shown and described several different embodiments of the invention, simply by way of illustration of some of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated herein and forming a part of the specification, illustrate several aspects of the present invention and together with the description serve to explain certain principles of the invention. In the drawings:

FIG. 1 is a schematical block illustration of the method of the present invention; and

FIG. 2 is a schematical block diagram illustrating the relationship between the various entities involved in the targeted marketing concept of the present invention.

Reference will now be made in detail to the present preferred embodiment of the invention, examples of which are illustrated in the accompanying drawings.

### DETAILED DESCRIPTION OF THE PREFERRED EMBODIMENTS OF THE INVENTION

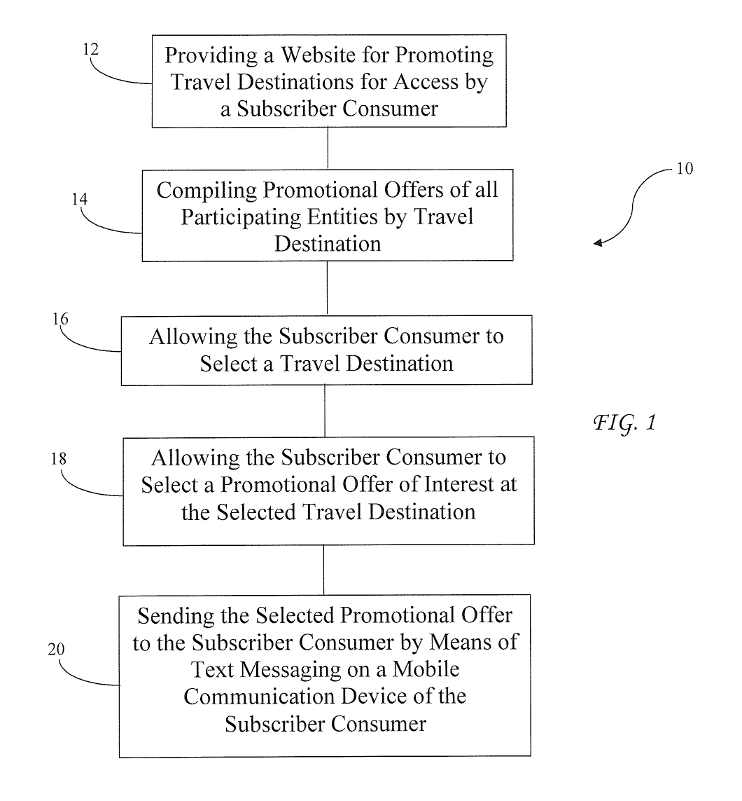

As illustrated in FIG. 1, the present invention relates to a method (10) of promoting travel that may be broadly described as comprising the steps of (a) providing a website for promoting travel destinations for access by a subscriber consumer (12); (b) compiling promotional offers of all participating entities by travel destination (14); (c) allowing the subscriber consumer to select a travel destination (16); (d) allowing the subscriber consumer to select a promotional offer of interest at the selected travel destination (18); and (e) sending the selected promotional offer to the subscriber consumer by means of text messaging on a mobile communication device of the subscriber consumer (20).

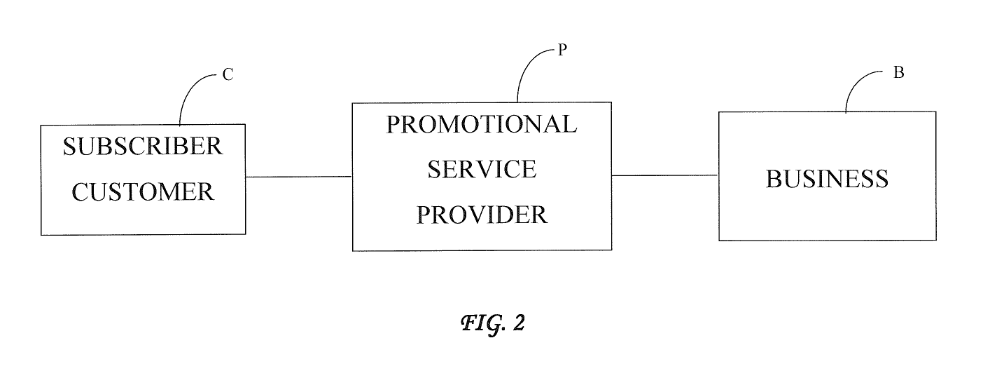

As illustrated in FIG. 2, a promotional service provider P is engaged by a business B to promote the business to subscriber customers C. Toward this end, the promotional service provider P utilizes a mobile phone text messaging service. Such a text messaging service is a permission based service requiring the registration of a customer or potential customer of the business B. Two mediums are provided for a customer C to join or subscribe to the text messaging service. The first provides for customer registration via an internet website. The second provides for customer registration via mobile phone texting. Thus, a potential customer or existing customer C may utilize his mobile phone to register via the cell phone registration medium.

In order to register, a customer C provides personal data which is stored in memory by the promotional service provider P. That data includes, but may not necessarily be limited to, residence information including address and mobile phone number. The individual registering may then review a list of businesses represented by the promotional service provider P via the text messaging service. The individual or subscriber customer C then selects those businesses B from which it is desired to receive discounts, coupons and other communication. This activates text messaging services whereby the promotional service provider P provides promotional information of the selected business or businesses B to the subscriber customer C with pre-authorized customer approval.

All customers C for any particular business B are then maintained on a list by the promotional service provider P. The service provider P may use the system to provide a business B with an indication of how many times a particular individual or customer C has taken advantage of a coupon or special offer sent by text message. Thus, the list represents valuable marketing information stored by the promotional service provider P. This greatly increases the value of the service provided by the promotional service provider P. More specifically, the business B is provided with an incentive to maintain the service.

In accordance with the particular method of the present invention, it should be appreciated that the targeted marketing is travel destination specific. Specifically, the promotional service provider P provides an internet website promoting travel destinations for access by the subscriber customer/consumer C. The promotional offers of each business or participating entity B are compiled by travel destination. Participating entity or business is broadly defined to include, but not be limited to, retail and wholesale businesses, museums, sports facilities, amusement parks, tourist attractions and the like.

The subscriber consumer C can review the promotional offers available at the selected destination and select promotional offers of interest. The selected promotional offers are then sent to the subscriber customer/consumer C by means of text messaging to the mobile communication device of the customer/consumer.

In accordance with an additional aspect of the present invention, the mobile phone text messaging service provided by the promotional service provider P includes a global positioning satellite monitor. The global positioning satellite (GPS) monitor locates the individual subscriber customer or potential customer C by monitoring the global positioning satellite or GPS feature of the mobile phone carried by that customer. Once the individual customer C reaches an identified or preselected travel destination, the promotional service provider P sends the requested promotional information, discount coupons and the like to the individual customer C.

In one particularly useful embodiment of the invention, the method includes determining the location of the consumer customer C by monitoring the GPS system of the customer's mobile communication device. Upon request of the customer C, the service provider P sends travel directions from the current location of the customer to the desired travel destination location such as a museum. The travel directions sent by text messaging may be quickly and easily received by the customer C on his mobile communication device. Updated directions can be sent automatically at given time intervals or manually requested by the customer C as he travels toward the final desired destination. This guidance feature is a particularly useful asset to the traveler in an unfamiliar city.

The foregoing description of the preferred embodiments of the present invention have been presented for purposes of illustration and description. It is not intended to be exhaustive or to limit the invention to the precise form disclosed. Obvious modifications or variations are possible in light of the above teachings. The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims in their fair and broad interpretation in any way.

What is claimed:

1. A method of promoting travel, comprising:
providing a website for promoting travel destinations for access by a subscriber consumer;
compiling promotional offers of all participating entities by travel destination;
allowing said subscriber consumer to select a travel destination;
allowing said subscriber consumer to select a promotional offer of interest at said selected travel destination; and
sending said selected promotional offer to said subscriber consumer by means of text messaging on a mobile communication device of said subscriber consumer.

2. The method of claim 1, including determining location of said subscriber consumer by monitoring GPS system of said mobile communication device and sending most up-to-date promotional offer to said mobile communication device when said mobile communication device is detected at said travel destination.

3. The method of claim 2, including sending travel directions to a site of a particular promotional offer.
